(19) United States
(12) Patent Application Publication
(10) Pub. No.: US 2023/0068362 A1
(43) Pub. Date: Mar. 2, 2023

(54) VEHICLE TRAVELING CONTROL DEVICE, METHOD, AND STORAGE MEDIUM

(71) Applicant: TOYOTA JIDOSHA KABUSHIKI KAISHA, Toyota-shi Aichi-ken (JP)

(72) Inventor: Hideyuki Wakamiya, Mishima-shi Shizuoka-ken (JP)

(73) Assignee: TOYOTA JIDOSHA KABUSHIKI KAISHA, Toyota-shi Aichi-ken (JP)

(21) Appl. No.: 17/863,827

(22) Filed: Jul. 13, 2022

(30) Foreign Application Priority Data
Aug. 31, 2021 (JP) 2021-141838

(51) Int. Cl. B60W 30/16; B60W 30/165; B60W 30/14; B60W 40/04; B60W 40/105

(52) U.S. Cl. CPC B60W 30/162; B60W 30/165; B60W 30/146; B60W 40/04; B60W 40/105; B60W 2520/105; B60W 2554/406; B60W 2554/802; B60W 2554/804

(57) ABSTRACT

A vehicle traveling control device is capable of implementing an automatic driving mode that can cause an own vehicle to travel following a preceding vehicle within a predetermined speed range. The vehicle traveling control device includes an acquiring unit that acquires traffic congestion information relating to a traffic congestion nearby the own vehicle, and a control unit that suppresses acceleration of the own vehicle in a first case in which presence of a traffic congestion is detected based on the traffic congestion information, and the own vehicle can be accelerated, during implementation of the automatic driving mode.

### CROSS-REFERENCE TO RELATED APPLICATION

This application claims priority to Japanese Patent Application No. 2021-141838 filed on Aug. 31, 2021, incorporated herein by reference in its entirety.

### BACKGROUND

### 1. Technical Field

The present disclosure relates to a technical field of a vehicle traveling control device, a method, and a storage medium.

### 2. Description of Related Art

There is proposed, as this type of device, a device that, when acceleration suppression conditions based on traffic congestion information are satisfied while executing follow-up traveling control, reduces the magnitude of a target acceleration as compared to a case in which an acceleration suppression limit is not satisfied, for example (see Japanese Unexamined Patent Application Publication No. 2020-117009 (JP 2020-117009 A)). Examples of other related technology include Japanese Unexamined Patent Application Publication No. 2020-152288 (JP 2020-152288 A) and Japanese Patent No. 6580108 (JP 6580108 B). JP 2020-152288 A discloses that when an own vehicle enters a narrow road during execution of a Level 3 automatic driving mode, the driving mode is switched to a driving mode desired by a driver. JP 6580108 B discloses that when the automatic driving level of an automatic driving vehicle that travels following a vehicle traveling ahead under follow-up traveling control is Level 3, and the own vehicle is starting from a standstill, an inter-vehicle distance between the own vehicle and the vehicle traveling ahead is set to be greater than the inter-vehicle distance when the automatic driving level is Level 2.

### SUMMARY

In the technology described in JP 2020-117009 A, when the target acceleration is suppressed due to the acceleration suppression limitation, the inter-vehicle distance between the own vehicle and a preceding vehicle tends to become great. Consequently, due to the inter-vehicle distance between the two vehicles becoming relatively great, the own vehicle may not be able to follow the preceding vehicle (e.g., follow-up traveling control must be cancelled). That is to say, there is room for improvement in the technology described in JP 2020-117009 A.

The present disclosure has been made in view of the above circumstances, and it is an object thereof to provide a vehicle traveling control device, a method, and a storage medium, that enable follow-up traveling control to be continued for a relatively long time.

A vehicle traveling control device according to an aspect of the present disclosure is a vehicle traveling control device that implements an automatic driving mode causing an own vehicle to travel following a preceding vehicle within a predetermined speed range, and includes an acquiring unit that acquires traffic congestion information relating to a traffic congestion nearby the own vehicle, and a control unit that, in a first case in which presence of a traffic congestion is detected based on the traffic congestion information, and the own vehicle is acceleratable, during implementation of the automatic driving mode, suppresses acceleration of the own vehicle.

A vehicle traveling control method according to an aspect of the present disclosure is a vehicle traveling control method of a vehicle traveling control device that implements an automatic driving mode causing an own vehicle to travel following a preceding vehicle within a predetermined speed range, and includes the vehicle traveling control device acquiring traffic congestion information relating to a traffic congestion nearby the own vehicle, and the vehicle traveling control device performing control in which acceleration of the own vehicle is suppressed, in a first case in which presence of a traffic congestion is detected based on the traffic congestion information, and the own vehicle is acceleratable, during implementation of the automatic driving mode.

A storage medium according to an aspect of the present disclosure stores instructions that are executable by one or more processors in a vehicle traveling control device that implements an automatic driving mode causing an own vehicle to travel following a preceding vehicle within a predetermined speed range, and that cause the one or more processors to perform functions including acquiring traffic congestion information relating to a traffic congestion nearby the own vehicle, and suppressing acceleration of the own vehicle in a first case in which presence of a traffic congestion is detected based on the traffic congestion information, and the own vehicle is acceleratable, during implementation of the automatic driving mode.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram illustrating a configuration of a vehicle according to an embodiment;

FIG. 2 is a diagram illustrating an example of traffic conditions;

FIG. 3 is a flowchart showing operations of an electronic control unit (ECU) according to the embodiment; and

FIG. 4 is a block diagram illustrating a configuration of a computer according to the embodiment.

### DETAILED DESCRIPTION OF EMBODIMENTS

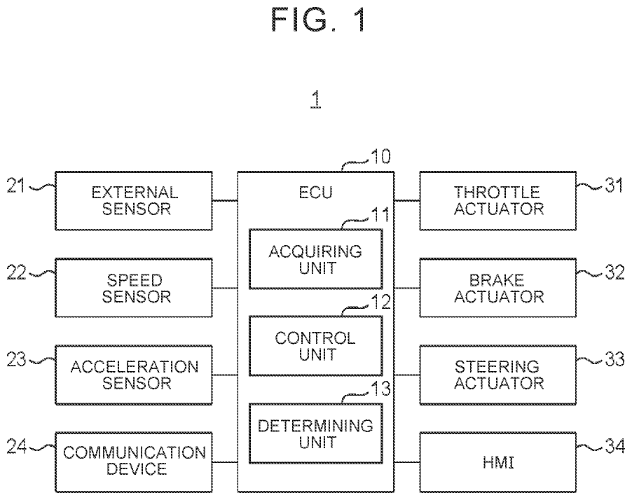

An embodiment of a vehicle traveling control device will be described with reference to FIGS. 1 to 3. An electronic control unit (ECU) 10 installed in a vehicle 1 will be described here as an example of the vehicle traveling control device. That is to say, in this embodiment, part of the ECU 10 for various controls of the vehicle 1 is used as the vehicle traveling control device.

In FIG. 1, the vehicle 1 includes the ECU 10, an external sensor 21, a speed sensor 22, an acceleration sensor 23, a communication device 24, a throttle actuator 31, a brake actuator 32, a steering actuator 33, and a human-machine interface (HMI) 34. It should be noted that various existing sensors such as a camera, a radar device, a LiDAR (an acronym of “Light Detection and Ranging”) device, and so forth, can be applied as the external sensor 21.

The ECU 10 is configured to be capable of executing automatic driving in which the driver is under duty of forward monitoring of the vehicle 1 (hereinafter, appropriately referred to as “first automatic driving”), and automatic driving in which the driver is exempt from duty of forward monitoring of the vehicle 1 (hereinafter, appropriately referred to as “second automatic driving”). The ECU 10 is capable of executing follow-up traveling control in which the vehicle 1 (i.e., the own vehicle) follows a preceding vehicle, for example, as the second automatic driving.

Here, follow-up traveling control as the second automatic driving is based on the premise that the vehicle 1 is traveling at a relatively low speed (no more than 60 km/h or the like), for example, in a congested section or the like. Accordingly, the follow-up traveling control as the second automatic driving can be executed when the speed of the vehicle 1 is no greater than an upper limit speed that is set in advance. Further, when the vehicle 1 is traveling at a relatively low speed, it is permissible for an inter-vehicle distance between the vehicle 1 and the preceding vehicle to be relatively small (several meters to several tens of meters, or the like). Accordingly, the follow-up traveling control as the second automatic driving can be executed when the inter-vehicle distance between the vehicle 1 and the preceding vehicle is no greater than an upper limit distance that is set in advance.

That is to say, the follow-up traveling control as the second automatic driving can be executed when the speed of the vehicle 1 is no greater than the upper limit speed, and the inter-vehicle distance between the vehicle 1 and the preceding vehicle is no greater than the upper limit distance. Accordingly, when the speed of the vehicle 1 exceeds the upper limit speed and/or the inter-vehicle distance between the vehicle 1 and the preceding vehicle exceeds the upper limit distance, during execution of the follow-up traveling control as the second automatic driving, the follow-up traveling control is canceled.

When the follow-up traveling control as the second automatic driving is canceled, the automatic driving is switched from the second automatic driving to the first automatic driving. Here, when the follow-up traveling control as the second automatic driving is canceled due to the speed of the vehicle 1 exceeding the upper limit speed, the automatic driving may be switched from the second automatic driving to follow-up traveling control as the first automatic driving. Alternatively, when the follow-up traveling control as the second automatic driving is canceled due to the inter-vehicle distance between the vehicle 1 and the preceding vehicle exceeding the upper limit distance, the automatic driving may be switched from the second automatic driving to constant speed control as the first automatic driving.

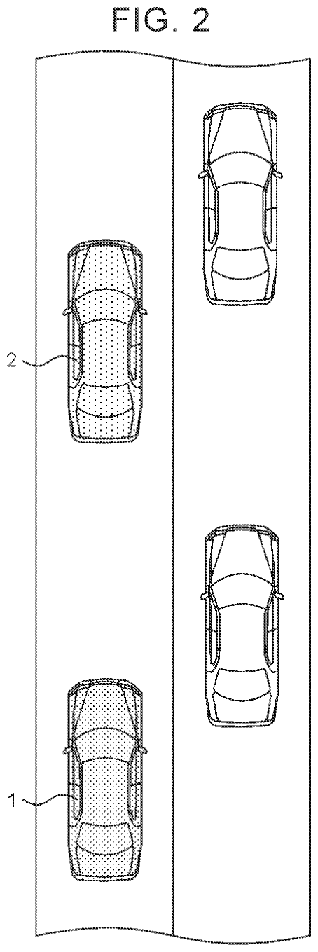

For example, a case will be considered in which the vehicle 1 follows a vehicle 2 as the preceding vehicle by the follow-up traveling control as the second automatic driving in a congested section, as illustrated in FIG. 2. The traffic flow in the congested section is not uniform (i.e., the vehicles in the congested section are not traveling at uniform low speed), and the traffic flow may become faster at certain portions, such as in a downhill section, for example.

When the vehicle 1 is traveling under follow-up traveling control as the second automatic driving, and the traffic flow temporarily becomes faster to the extent that the speed of the vehicle 1 exceeds the aforementioned upper limit speed, for example, causing the second automatic driving to switch to the first automatic driving, the driver is then under duty of forward monitoring of the vehicle 1. The speed of the vehicle 1 may then decrease immediately after switching from the second automatic driving to the first automatic driving, and the follow-up traveling control as the second automatic driving may be executable again. In such a case, the driver of the vehicle 1 may feel annoyed due to the switching from the second automatic driving to the first automatic driving.

Accordingly, the ECU 10 serving as the vehicle traveling control device controls the vehicle 1 so as to suppress cancellation of execution of the follow-up traveling control as the second automatic driving. The ECU 10 has an acquiring unit 11, a control unit 12, and a determining unit 13, as a logical block that is logically realized, or a processing circuit that is physically realized, therein (see FIG. 1). In the following description, “follow-up traveling control as second automatic driving” will be referred to as “follow-up traveling control during traffic congestion”.

The acquiring unit 11 acquires detection (measurement) results of each of the external sensor 21, the speed sensor 22, and the acceleration sensor 23. The acquiring unit 11 acquires, for example, information related to the Vehicle Information and Communication System (VICS) (a registered trademark), information from other vehicles that are present in the vicinity of the vehicle 1, and so forth, via the communication device 24. The acquiring unit 11 acquires traffic congestion information related to traffic congestion nearby the vehicle 1 from the information acquired via the communication device 24.

For example, when the follow-up traveling control during traffic congestion is executed, the control unit 12 controls the throttle actuator 31, the brake actuator 32, and the steering actuator 33, such that the vehicle 1 travels along a travel route at a target speed, based on the respective detection results of the external sensor 21, the speed sensor 22, and the acceleration sensor 23, acquired by the acquiring unit 11.

The determining unit 13 determines whether follow-up traveling control during traffic congestion, for example, can be continued, based on the detection results of each of the external sensor 21, the speed sensor 22, and the acceleration sensor 23, acquired by the acquiring unit 11.

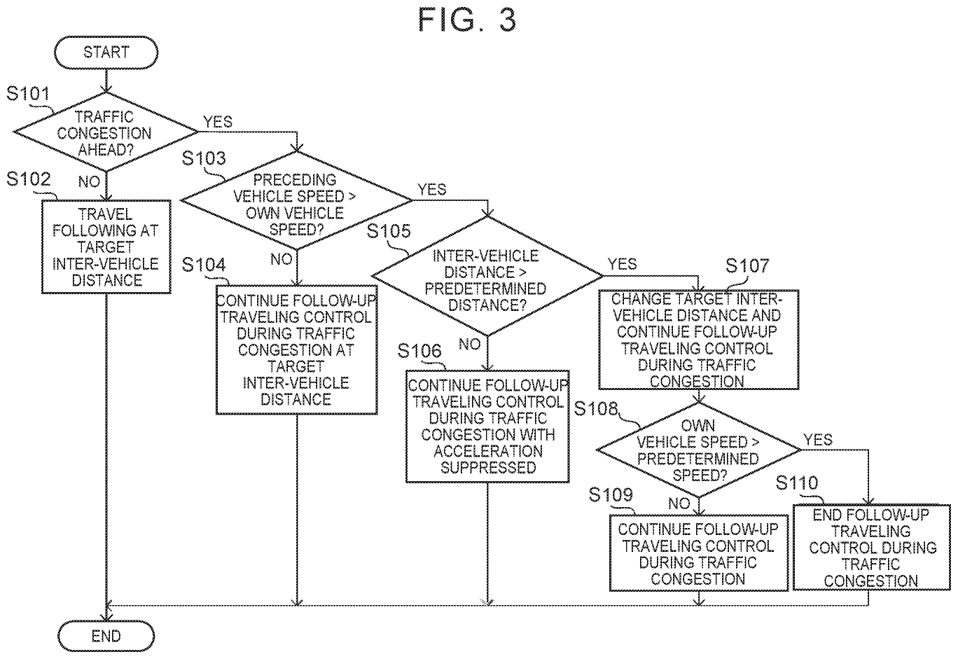

Next, the operations of the ECU 10 will be described with reference to the flowchart in FIG. 3. Here, assumption will be made that the vehicle 1 is traveling in a congested section, for example, and the follow-up traveling control during traffic congestion for causing the vehicle 1 to follow the vehicle 2 (see FIG. 2) is being executed.

In FIG. 3, the determining unit 13 determines whether there is traffic congestion ahead of the vehicle 1, based on traffic congestion information acquired by the acquiring unit 11 (step S101). In the processing of this step S101, determination is made regarding whether the congested section through which the vehicle 1 is currently traveling will continue down the road, or will let up.

When determination is made in the processing of step S101 that there is no traffic congestion ahead of the vehicle 1 (No in step S101), the control unit 12 controls the throttle actuator 31 and so forth based on detection results from the external sensor 21 and so forth, acquired by the acquiring unit 11 so that the inter-vehicle distance between the vehicle 1 and the vehicle 2 is a target inter-vehicle distance, and the vehicle 1 is caused to travel following the vehicle 2 (step S102). Note that the target inter-vehicle distance may be changed in accordance with the speed of the vehicle 1.

In this case, the traffic congestion will let up, and accordingly the speed of the vehicle 1 will increase. The control unit 12 switches from the second automatic driving to the first automatic driving when the speed of the vehicle 1 exceeds the upper limit speed at which the follow-up traveling control during traffic congestion can be executed, for example. In this case, the control unit 12 may execute the first automatic driving to cause the vehicle 1 to follow the vehicle 2. The control unit 12 may alert the driver via the HMI before switching from the second automatic driving to the first automatic driving.

When determination is made in the processing of step S101 that there is traffic congestion ahead of the vehicle 1 (Yes in step S101), the determining unit 13 determines whether the speed of the vehicle 2 (i.e., the speed of the preceding vehicle) is greater than the speed of the vehicle 1 (i.e., the speed of the own vehicle) (step S103).

When determination is made in the processing of step S103 that the speed of the vehicle 2 is no greater than the speed of the vehicle 1 (No in step S103), the control unit 12 controls the throttle actuator 31 and so forth based on detection results from the external sensor 21 and so forth, acquired by the acquiring unit 11, so that the inter-vehicle distance between the vehicle 1 and the vehicle 2 is the target inter-vehicle distance, and continues follow-up traveling control during traffic congestion (step S104). Thereafter, following a predetermined amount of time having elapsed, the processing of step S101 may be performed.

When determination is made in the processing of step S103 that the speed of the vehicle 2 is greater than the speed of the vehicle 1 (Yes in step S103), the determining unit 13 determines whether the inter-vehicle distance between the vehicle 1 and the vehicle 2 is greater than a predetermined distance (step S105). When determination is made in the processing of step S105 that the inter-vehicle distance between the vehicle 1 and the vehicle 2 is no greater than the predetermined distance (No in step S105), the control unit 12 suppresses acceleration of the vehicle 1 and continues follow-up traveling control during traffic congestion, while allowing the inter-vehicle distance between the vehicle 1 and the vehicle 2 to be greater than the target inter-vehicle distance (step S106). Thereafter, following a predetermined amount of time having elapsed, the processing of step S101 may be performed.

The “predetermined distance” is a value for determining whether to suppress acceleration of the vehicle 1, and is set in advance as a fixed value, or as a variable value in accordance with some physical quantity or parameter. The “predetermined distance” is a distance smaller than the upper limit distance at which the follow-up traveling control during traffic congestion can be executed. Such a predetermined distance may be set as a distance smaller than the upper limit distance by a predetermined value, for example, in accordance with responsivity of the vehicle 1. Specifically, the predetermined distance may be set as a distance regarding which the inter-vehicle distance between the vehicle 1 and the vehicle 2 does not exceed the upper limit distance, before the speed of the vehicle 1 increases after the inter-vehicle distance between the vehicle 1 and the vehicle 2 becomes greater than the predetermined distance and the suppression of the acceleration is lifted.

When determination is made in the processing of step S105 that the inter-vehicle distance between the vehicle 1 and the vehicle 2 is greater than the predetermined distance (Yes in step S105), the control unit 12 changes the target inter-vehicle distance, and continues the follow-up traveling control during traffic congestion without suppressing acceleration of the vehicle 1 (step S107). At this time, the target inter-vehicle distance after changing may be an upper limit distance at which the follow-up traveling control during traffic congestion can be executed.

Next, the determining unit 13 determines whether the speed of the vehicle 1 is greater than the predetermined speed (step S108). When determination is made in the processing of step S108 that the speed of the vehicle 1 is no greater than the predetermined speed (No in step S108), the control unit 12 continues the follow-up traveling control during traffic congestion (step S109). Thereafter, following a predetermined amount of time having elapsed, the processing of step S101 may be performed.

When determination is made in the processing of step S108 that the speed of the vehicle 1 is greater than the predetermined speed (Yes in step S108), the control unit 12 ends the follow-up traveling control during traffic congestion (i.e., execution of the follow-up traveling control during traffic congestion is cancelled) (step S110). At this time, the control unit 12 may alert the driver via the HMI. In the processing of step S110, the control unit 12 may switch from the second automatic driving to the first automatic driving, and execute the first automatic driving in which the vehicle 1 is caused to follow the vehicle 2, for example.

The “predetermined speed” is a value for determining whether to end the follow-up traveling control during traffic congestion, and may be set in advance as a fixed value, or a variable value in accordance with some physical quantity or parameter. The “predetermined speed” is a speed smaller than the upper limit speed at which the follow-up traveling control during traffic congestion can be executed. Such a predetermined speed may be set in accordance with the state of the driver. That is to say, in the second automatic driving, the driver is not under duty of forward monitoring of the vehicle 1. For this reason, when the follow-up traveling control during traffic congestion is being executed, the driver may be inattentive to the road so as to speak, such as intently viewing an electronic device unrelated to driving operations. Accordingly, the predetermined speed may be set to a speed such that the speed of the vehicle 1 will not exceed the upper limit speed at which follow-up traveling control during traffic congestion can be executed before the driver returns to driving operations, for example, based on the amount of time required for the driver to return to driving operations and the increase in speed of the vehicle 1 during this amount of time.

### Technical Aspects

The ECU 10 serving as the vehicle traveling control device suppresses the acceleration of the vehicle 1 when the speed of the vehicle 2 is greater than the speed of the vehicle 1 (i.e., the inter-vehicle distance between the vehicle 1 and the vehicle 2 is gradually increasing) and also the inter-vehicle distance between the vehicle 1 and the vehicle 2 is no more than the predetermined distance, during execution of the follow-up traveling control during traffic congestion. Thus, the speed of the vehicle 1 can be suppressed from exceeding the upper limit speed at which the follow-up traveling control during traffic congestion can be executed.

Further, when the speed of the vehicle 2 is greater than the speed of the vehicle 1 and the inter-vehicle distance between the vehicle 1 and the vehicle 2 is greater than the predetermined distance when the follow-up traveling control during traffic congestion is being executed, the ECU 10 attempts to continue the follow-up traveling control during traffic congestion without suppressing acceleration of the vehicle 1. Thus, the inter-vehicle distance between the vehicle 1 and the vehicle 2 can be suppressed from exceeding the upper limit distance at which the follow-up traveling control during traffic congestion can be executed due to suppression of the acceleration of the vehicle 1.

According to such a configuration, even when the speed of the vehicle 2 that is the preceding vehicle temporarily increases in a congested section, cancellation of execution of the follow-up traveling control during traffic congestion can be suppressed. That is to say, switching from the second automatic driving to the first automatic driving can be suppressed. In other words, according to the ECU 10, the follow-up traveling control during traffic congestion can be continued for a relatively long time.

After switching from the second automatic driving to the first automatic driving, the speed of the vehicle 1 may decrease, and the second automatic driving (follow-up traveling control during traffic congestion here) may become executable. When switching between the first automatic driving and the second automatic driving occurs relatively frequently, the driver of the vehicle 1 may find this annoying. Conversely, according to the ECU 10, execution of the follow-up traveling control during traffic congestion can be suppressed from being canceled, and thus the driver can be kept from feeling annoyed.

### Computer Program

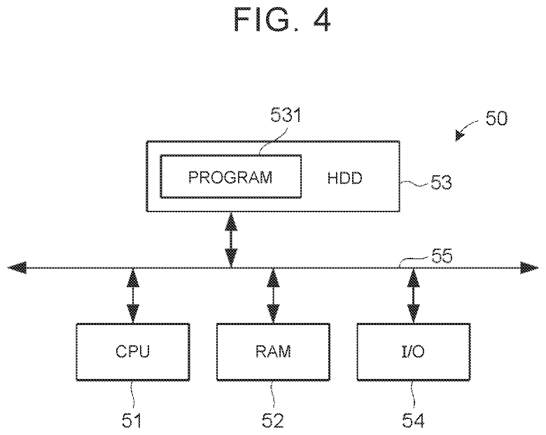

An embodiment relating to a computer program will be described with reference to FIG. 4. FIG. 4 is a block diagram illustrating a configuration of a computer 50 according to the embodiment.

In FIG. 4, the computer 50 makes up a vehicle traveling control device (e.g., the ECU 10 described above). The computer 50 includes a central processing unit (CPU) 51, random-access memory (RAM) 52, a hard disk drive (HDD) 53, and an input/output (I/O) 54. The CPU 51, the RAM 52, the HDD 53, and the I/O 54 are connected to each other by a bus 55. A computer program 531 according to the present embodiment is stored in the HDD 53 in advance. The CPU 51 may be made up of one or a plurality of processors.

The processing of the CPU 51 by the computer program 531 will be described. The CPU 51 determines whether there is traffic congestion ahead of the own vehicle, based on traffic congestion information acquired via the I/O 54. When determination is made that there is no traffic congestion ahead of the own vehicle, the CPU 51 controls the throttle actuator 31 and so forth based on detection results from the external sensor 21 and so forth, acquired via the I/O 54 so that the inter-vehicle distance between the own vehicle and the preceding vehicle is the target inter-vehicle distance, thereby causing the own vehicle to travel following the preceding vehicle. In this case, the automatic driving is switched from the second automatic driving to the first automatic driving when the speed of the own vehicle exceeds the upper limit speed at which the follow-up traveling control during traffic congestion can be executed.

When determination is made that there is traffic congestion ahead of the own vehicle, the CPU 51 determines whether the speed of the preceding vehicle is greater than the speed of the own vehicle. When determination is made that the speed of the preceding vehicle is no greater than the speed of the own vehicle, the CPU 51 continues the follow-up traveling control during traffic congestion while keeping the inter-vehicle distance between the own vehicle and the preceding vehicle at the target inter-vehicle distance.

When determination is made that the speed of the preceding vehicle is greater than the speed of the own vehicle, the CPU 51 determines whether the inter-vehicle distance between the own vehicle and the preceding vehicle is greater than the predetermined distance. When determination is made that the inter-vehicle distance between the own vehicle and the preceding vehicle is no greater than the predetermined distance, the CPU 51 suppresses the acceleration of the own vehicle and continues the follow-up traveling control during traffic congestion, while allowing the inter-vehicle distance between the own vehicle and the preceding vehicle to be greater than the target inter-vehicle distance.

When determination is made that the inter-vehicle distance between the own vehicle and the preceding vehicle is greater than the predetermined distance, the CPU 51 changes the target inter-vehicle distance and continues the follow-up traveling control during traffic congestion without suppressing the acceleration of the own vehicle. Next, the CPU 51 determines whether the speed of the own vehicle is greater than the predetermined speed. When determination is made that the speed of the own vehicle is no greater than the predetermined speed, the CPU 51 continues the follow-up traveling control during traffic congestion. On the other hand, when determination is made that the speed of the own vehicle is greater than the predetermined speed, the CPU 51 ends the follow-up traveling control during traffic congestion.

Note that the computer program 531 may be stored in the HDD 53 by the computer 50 reading the computer program 531 from a recording medium like an optical disk such as compact disc read-only memory (CD-ROM) or the like, or Universal Serial Bus (USB) memory or the like, that stores the computer program 531, for example. The recording media described above are examples of a storage medium. Alternatively, the computer program 531 may be stored in the HDD 53 by the computer 50 downloading the computer program 531 over a network such as the Internet, for example.

According to the computer program 531, the follow-up traveling control during traffic congestion can be continued for a relatively long time, in the same way as with the ECU 10 serving as the vehicle traveling control device in the above-described embodiment. According to the computer program 531, the ECU 10 serving as the vehicle traveling control device in the above-described embodiment can be realized relatively easily.

various aspects of the present disclosure derived from the embodiment described above will be described below.

A vehicle traveling control device according to an aspect of the present disclosure is a vehicle traveling control device that implements an automatic driving mode causing an own vehicle to travel following a preceding vehicle within a predetermined speed range, and includes an acquiring unit that acquires traffic congestion information relating to a traffic congestion nearby the own vehicle and a control unit that, in a first case in which presence of a traffic congestion is detected based on the traffic congestion information, and the own vehicle is acceleratable, during implementation of the automatic driving mode, suppresses acceleration of the own vehicle.

In the above-described embodiment, the “ECU 10” corresponds to an example of the “vehicle traveling control device”, the “acquiring unit 11” corresponds to an example of the “acquiring unit”, the “control unit 12” corresponds to an example of the “control unit”, and the “follow-up traveling control during traffic congestion” corresponds to an example of “an automatic driving mode causing an own vehicle to travel following a preceding vehicle within a predetermined speed range”. The “when the own vehicle is acceleratable, during implementation of the automatic driving mode” may include, for example, when the distance to the preceding vehicle that the own vehicle is following from the own vehicle becomes greater, and the preceding vehicle to be followed is switched due to the preceding vehicle that was being followed changing lanes, and a distance to a new preceding vehicle is relatively great, or the like.

In the vehicle traveling control device, the control unit may suppress acceleration of the own vehicle so that a speed of the own vehicle does not exceed a predetermined speed range in the first case.

In the vehicle traveling control device, the control unit (i) may suppress acceleration of the own vehicle when the preceding vehicle is faster than the own vehicle in the first case, and (ii) may cause the own vehicle to travel following the preceding vehicle such that a distance between the own vehicle and the preceding vehicle is a predetermined target distance, when presence of a traffic congestion is detected based on the traffic congestion information and the preceding vehicle is slower than the own vehicle, during execution of the automatic driving mode.

In the vehicle traveling control device, the control unit (i) may suppress acceleration of the own vehicle when an inter-vehicle distance between the own vehicle and the preceding vehicle is smaller than a predetermined distance in the first case, and (ii) may cancel suppression of acceleration of the own vehicle in a second case in which the inter-vehicle distance reaches the predetermined distance in the first case.

In this aspect, the control unit may cause the own vehicle to travel following the preceding vehicle such that the inter-vehicle distance is maintained at the predetermined distance in the second case. In this aspect, the predetermined distance may be a distance within a predetermined distance range in which the own vehicle is caused to travel following the preceding vehicle in the automatic driving mode.

The vehicle traveling control device (10) may implement the automatic driving mode when a speed of the own vehicle is no greater than an upper limit speed that is set in advance.

The control unit (12) may suppress acceleration when at least one of conditions of when presence of a traffic congestion is detected based on the traffic congestion information, and a distance to the preceding vehicle that the own vehicle is following from the own vehicle becomes greater, and when presence of a traffic congestion is detected based on the traffic congestion information, and the preceding vehicle to be followed is switched and a distance to the new preceding vehicle is relatively great, is satisfied.

A vehicle traveling control method according to an aspect of the present disclosure is a vehicle traveling control method of a vehicle traveling control device that implements an automatic driving mode causing an own vehicle to travel following a preceding vehicle within a predetermined speed range, and includes the vehicle traveling control device acquiring traffic congestion information relating to a traffic congestion nearby the own vehicle, and the vehicle traveling control device performing control in which acceleration of the own vehicle is suppressed, in a first case in which presence of a traffic congestion is detected based on the traffic congestion information, and the own vehicle is acceleratable, during implementation of the automatic driving mode.

A storage medium according to an aspect of the present disclosure stores instructions that are executable by one or more processors in a vehicle traveling control device that implements an automatic driving mode causing an own vehicle to travel following a preceding vehicle within a predetermined speed range, and that cause the one or more processors to perform functions including acquiring traffic congestion information relating to a traffic congestion nearby the own vehicle, and suppressing acceleration of the own vehicle in a first case in which presence of a traffic congestion is detected based on the traffic congestion information, and the own vehicle is acceleratable, during implementation of the automatic driving mode.

The present disclosure is not limited to the above-described embodiment, and can be appropriately modified without departing from the essence or spirit of the present disclosure that can be read from the claims and the entire specification, and a vehicle traveling control device, method, and storage medium, with such modifications, are also within the technical scope of the present disclosure.

What is claimed is:

1. A vehicle traveling control device that implements an automatic driving mode causing an own vehicle to travel following a preceding vehicle within a predetermined speed range, the vehicle traveling control device comprising:
an acquiring unit that acquires traffic congestion information relating to a traffic congestion nearby the own vehicle; and
a control unit that, in a first case in which presence of a traffic congestion is detected based on the traffic congestion information, and the own vehicle is acceleratable, during implementation of the automatic driving mode, suppresses acceleration of the own vehicle.

2. The vehicle traveling control device according to claim 1, wherein the control unit suppresses acceleration of the own vehicle such that a speed of the own vehicle does not exceed a predetermined speed range in the first case.

3. The vehicle traveling control device according to claim 1, wherein the control unit suppresses acceleration of the own vehicle when the preceding vehicle is faster than the own vehicle in the first case, and causes the own vehicle to travel following the preceding vehicle such that a distance between the own vehicle and the preceding vehicle is a predetermined target distance, when presence of a traffic congestion is detected based on the traffic congestion information and the preceding vehicle is slower than the own vehicle, during implementation of the automatic driving mode.

4. The vehicle traveling control device according to claim 1, wherein the control unit suppresses acceleration of the own vehicle when an inter-vehicle distance between the own vehicle and the preceding vehicle is smaller than a predetermined distance in the first case, and cancels suppression of acceleration of the own vehicle in a second case in which the inter-vehicle distance reaches the predetermined distance in the first case.

5. The vehicle traveling control device according to claim 4, wherein the control unit causes the own vehicle to travel following the preceding vehicle such that the inter-vehicle distance is maintained at the predetermined distance in the second case.

6. The vehicle traveling control device according to claim 4, wherein the predetermined distance is a distance within a predetermined distance range in which the own vehicle is caused to travel following the preceding vehicle in the automatic driving mode.

7. The vehicle traveling control device according to claim 1, wherein the vehicle traveling control device implements the automatic driving mode when a speed of the own vehicle is no greater than an upper limit speed that is set in advance.

8. The vehicle traveling control device according to claim 1, wherein the control unit suppresses acceleration when at least one of conditions of
when presence of a traffic congestion is detected based on the traffic congestion information, and a distance to the preceding vehicle that the own vehicle is following from the own vehicle becomes greater, and
when presence of a traffic congestion is detected based on the traffic congestion information, and the preceding vehicle to be followed is switched and a distance to a new preceding vehicle is relatively great, is satisfied.

9. A vehicle traveling control method of a vehicle traveling control device that implements an automatic driving mode causing an own vehicle to travel following a preceding vehicle within a predetermined speed range, the vehicle traveling control method comprising:
the vehicle traveling control device acquiring traffic congestion information relating to a traffic congestion nearby the own vehicle; and
the vehicle traveling control device performing control in which acceleration of the own vehicle is suppressed, in a first case in which presence of a traffic congestion is detected based on the traffic congestion information, and the own vehicle is acceleratable, during implementation of the automatic driving mode.

10. A non-transitory storage medium storing instructions that are executable by one or more processors in a vehicle traveling control device that implements an automatic driving mode causing an own vehicle to travel following a preceding vehicle within a predetermined speed range, and that cause the one or more processors to perform functions comprising:
acquiring traffic congestion information relating to a traffic congestion nearby the own vehicle, and
suppressing acceleration of the own vehicle in a first case in which presence of a traffic congestion is detected based on the traffic congestion information, and the own vehicle is acceleratable, during implementation of the automatic driving mode.
